(19) United States
(12) Patent Application Publication
(10) Pub. No.: US 2012/0258334 A1
(43) Pub. Date: Oct. 11, 2012

(54) TRANSPARENT CONDUCTIVE ELEMENT AND TRANSPARENT CONDUCTIVE ELEMENT MANUFACTURING METHOD

(75) Inventors: Naoto Kaneko, Miyagi (JP); Mikihisa Mizuno, Miyagi (JP)

(73) Assignee: SONY CORPORATION, Tokyo (JP)

(21) Appl. No.: 13/431,606

(22) Filed: Mar. 27, 2012

(30) Foreign Application Priority Data
Apr. 6, 2011 (JP) 2011-084152

(51) Int. Cl. B32B 27/20; B05D 3/12; B05D 3/02; B05D 5/12; B05D 1/38

(52) U.S. Cl. 428/701; 428/702; 427/58

(57) ABSTRACT

A transparent conductive element includes: a base; a transparent conductive film which is formed of a transparent conductive material on the base; and a protective layer which coats the transparent conductive film.

### CROSS REFERENCES TO RELATED APPLICATIONS

The present application claims priority to Japanese Priority Patent Application JP 2011-084152 filed in the Japan Patent Office on Apr. 6, 2011, the entire content of which is hereby incorporated by reference.

### BACKGROUND

The present disclosure relates to a transparent conductive element and a manufacturing method thereof

Transparent conductive films have attracted attention since these are used as a major member for electronic industries such as touch panels, FPD, solar cells, EMI, and optical filters, and are expected to be more widely spread.

Currently, a transparent conductive film forming method mainly used is a dry process such as a vacuum deposition method and a sputtering method. However, with an increase in size of a substrate on which a film is to be formed, there are problems in that the manufacturing apparatus is made large-scale and the cost increases.

Meanwhile, in recent years, transparent conductive films using a coating system, which is a wet process, have attracted great attention since production by a Roll-To-Roll (R2R) system in which the manufacturing cost is low is possible using a flexible base such as plastic which is lightweight and cheap. However, there are problems in that the resistance value is higher than in the case of film formation by a dry process and deterioration occurs with the lapse of time.

As an example considering the formation of a transparent conductive film by a coating method, for example, a manufacturing method is known in which using an ink in which conductive particles are dispersed such as a silica sol liquid (see Japanese Patent No. 4323156) containing ITO particulates or a coating liquid (see Japanese Patent No. 4287124) containing ITO particulates, silicate for a binder, and a polar solvent, an ITO transparent conductive film is formed on a substrate such as glass by performing coating by a method such as spin coating, spray coating or dip coating, drying, and baking.

However, in the method of forming a transparent conductive film by coating a transparent substrate with ink in which conductive particles are dispersed, contact between the conductive particles is generally disturbed by the binder having an insulating property. Therefore, there is a problem in that the initial sheet resistance value of the formed transparent conductive film is two orders of magnitude higher than that of a transparent conductive film formed by a sputtering method.

In addition, in Japanese Unexamined Patent Application Publication No. 2010-146757, there is a description of a transparent conductive film manufacturing method including a process of selectively performing a heat treatment only on a transparent conductive film. In this case, the initial sheet resistance value is reduced to be the same as that by a dry process. However, no improvement is shown in deterioration with the lapse of time.

### SUMMARY

It is desirable to suppress the deterioration of a transparent conductive layer with the lapse of time in a transparent conductive element.

According to an embodiment of the present disclosure, there is provided a transparent conductive element including: a base; a transparent conductive film which is formed of a transparent conductive material on the base; and a protective layer which coats the transparent conductive film.

For example, the above-described protective layer is formed from a resin or a material in which an inorganic filler is added to the resin.

According to another embodiment of the present disclosure, there is provided a transparent conductive element manufacturing method including: forming a transparent conductive film by coating a base with a transparent conductive material; subjecting the transparent conductive film to post-processing such as baking and pressing; and coating the transparent conductive film with a protective layer.

In a coating type low-resistance transparent conductive film, even when a coating film (transparent conductive film) is formed, deterioration occurs with the lapse of time. That is, the resistance value increases with the lapse of time and a function as an electrode element deteriorates. In the technique of the present disclosure, the transparent conductive film is over-coated with a protective layer to prevent oxygen being adsorbed to the transparent conductive film and to suppress deterioration in resistance.

According to an embodiment of the present disclosure, it is possible to realize a transparent conductive element in which the deterioration of a transparent conductive film with the lapse of time is suppressed and the low resistance is maintained. Accordingly, it is appropriate to use the transparent conductive element in, for example, a transparent conductive electrode of a capacitive touch panel.

Additional features and advantages are described herein, and will be apparent from the following Detailed Description and the figures.

### BRIEF DESCRIPTION OF THE FIGURES

FIGS. 1A and 1B are diagrams illustrating the structure of a transparent conductive element according to an embodiment of the present disclosure.

FIGS. 2A to 2D are flowcharts of processes of manufacturing the transparent conductive element according to the embodiment.

FIG. 3 is a diagram schematically illustrating a manufacturing process I according to the embodiment.

FIG. 4 is a diagram illustrating an input device using the transparent conductive element according to the embodiment.

FIG. 5 is a table illustrating deterioration in resistance of examples and comparative examples.

### DETAILED DESCRIPTION

Hereinafter, embodiments will be described in the following order.
<1. Configuration of Transparent Conductive Element>
<2. Manufacturing of Transparent Conductive Element>
<3. Processes of Manufacturing Transparent Conductive Film Formed to Have Pattern>
<4. Input Device Using Transparent Conductive Element>

### <1. Configuration of Transparent Conductive Element>

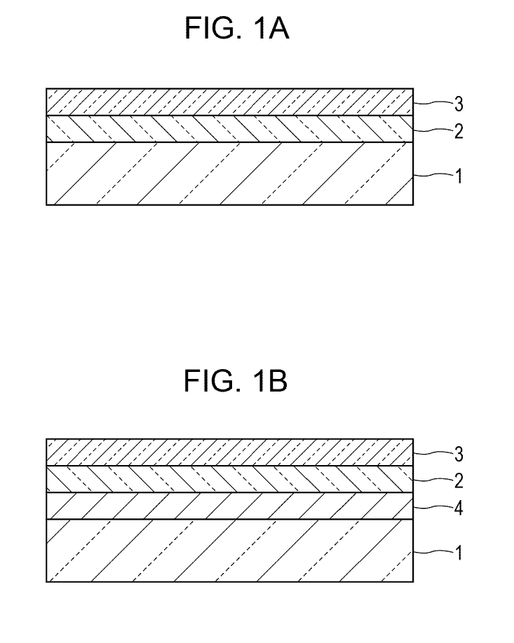

FIG. 1A schematically shows the structure of a transparent conductive element.

The transparent conductive element has a laminate structure of a base 1, a transparent film 2, and a protective layer 3. The transparent conductive film 2 is formed of a transparent conductive material having a predetermined pattern, and due to the transparent conductive film 2, the transparent conductive element functions as an electrode element. The protective layer 3 is stacked to coat the transparent conductive film 2.

In this embodiment, the protective layer 3 is formed on the transparent conductive film 2 to suppress the deterioration in sheet resistance of the transparent conductive film 2 with the lapse of time.

Although described later in detail, the protective layer 3 uses a resin such as a heat curable resin or an UV curable resin. In addition, an inorganic filler and the like may be mixed with the resin.

The transparent electrode film 2 is formed using, for example, a conductive metal oxide filler.

The transparent conductive element according to this embodiment can be appropriately used as an electrode element of a capacitive touch panel and the like.

The transparent conductive element according to this embodiment may have a structure shown in FIG. 1B. In this example, the transparent conductive film 2 is formed on the base 1 via an anchor layer 4.

Hereinafter, the respective layers of the transparent conductive element will be described in detail.

### Base 1

The material of the base 1 is not particularly limited, and various bases can be used if these are transparent.

Examples thereof include transparent inorganic substrates such as quartz, sapphire and glass and transparent plastic substrates such as polyethylene terephthalate, polyethylene naphthalate, polycarbonate, polystyrene, polyethylene, polypropylene, polyphenylene sulfide, polyvinylidene fluoride, tetraacetyl cellulose, brominated phenoxy, aramids, polyimides, polystyrenes, polyarylates, polysulfones and polyolefins. Among them, a substrate having a high transmission in a visible light region is particularly preferably used, but the material is not limited to them.

The thickness of the base 1 which is a transparent substrate is not particularly limited, but can be freely selected in consideration of a light transmission, a moisture vapor transmission and the like.

### Transparent Conductive Film 2

Examples of the filler which is a material of the transparent conductive film 2 include a conductive metal oxide filler typified by ITO.

Specific examples of the conductive metal oxide filler include ITO, ATO, PTO, FTO, IFO, AZO, GZO, IZO, FZO, ZnO, and the like. Among them, ITO is particularly preferably used. The kind of the conductive metal oxide filler is not limited to them, and these can also be used in a mixture of two or more kinds.

It is desirable that the shape of the conductive metal oxide filler be at least one selected from a spherical shape, a cubic shape, a spindle shape, a rod shape, a needle shape, a wire shape, and a tube shape.

From the viewpoint of transmission of visible light, the particle diameter of the conductive metal oxide filler is preferably in the range of from 1 to 100 nm in terms of an average particle diameter of primary particles.

ITO is preferably 20% or less of a doped quantity of SnO₂. Examples of commercialized products thereof include EC and ES series manufactured by Titan Kogyo, Ltd., Nano Tek ITO-R manufactured by CIK NanoTek Corporation, Nanodisper ITO and ITO nanoparticles manufactured by Tomoe Works. Co., Ltd., ITO paste manufactured by Toyo Ink Co., Ltd., E-ITO manufactured by Mitsubishi Materials Electronic Chemicals Co., Ltd., 49N-5090 and 49N-5090B manufactured by Inframat Advanced Materials, ITO-P100 manufactured by Shanghai Huzheng Nanotechnology Co., Ltd., and the like.

Otherwise, ITO having a predetermined particle diameter may be produced by an existing method such as thermal decomposition of an indium compound, a tin compound and the like.

Examples of commercialized products of ATO include EC and ES series manufactured by Titan Kogyo, Ltd., ATO paste manufactured by Toyo Ink Co., Ltd., T-1 and TDL series manufactured by Mitsubishi Materials Electronic Chemicals Co., Ltd., SN and FS series manufactured by Ishihara Sangyo Kaisha, Ltd., CP095 manufactured by Tayca Corporation, SG-AT50 manufactured by DKSH Holding Ltd., ATO-P100 manufactured by Shanghai Huzheng Nanotechnology Co., Ltd., and the like.

As a commercialized product of PTO, EP and SP series manufactured by Mitsubishi Materials Electronic Chemicals Co., Ltd. can be used.

As a commercialized product of AZO, 23-K and Pazet CK manufactured by HakusuiTech Co., Ltd. can be used.

As a commercialized product of GZO, Pazet GK-40 manufactured by HakusuiTech Co., Ltd. can be used.

These can also be used in a mixture of two or more kinds.

A metallic filler may be mixed for the purpose of improving the conductive property. The metal is constituted by at least one selected from Ag, Au, Ni, Cu, Pd, Pt, Rh, Ir, Ru, Os, Fe, Co, and Sn.

It is desirable that the shape of the filler be at least one selected from a spherical shape, a cubic shape, a spindle shape, a rod shape, a needle shape, a wire shape, and a tube shape.

A solvent is used to dissolve and disperse the above-described conductive metal oxide filler.

Examples thereof include water, alcohols (methanol, ethanol, n-propanol, i-propanol, n-butanol, i-butanol, sec-butanol, tert-butanol, and the like), methyl ethyl ketone, isopropyl alcohol, acetone, anones(cyclohexanone and cyclopentanone), hydrocarbons(hexane), amides (DMF), sulfides (DMSO), butyl cellosolve, diacetone alcohol, butyl triglycol, propylene glycol monomethyl ether, propylene glycol monoethyl ether, ethylene glycol monomethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, methyl glycol, terpineol, and butyl carbitol acetate.

If necessary, additives such as a surfactant, a viscosity modifier, and a dispersing agent may be added for the purpose of improving a coating property of the base 1 and a pot life of the composition.

### Protective Layer 3

The protective layer 3 uses a resin. An inorganic filler may be added.

As the resin, an UV curable resin, a heat curable resin, a thermoplastic resin and the like are used.

Examples of the resin include an acrylonitrile-butadiene-styrene copolymer, an acrylonitrile-chlorinated polyethylene-styrene copolymer, an acrylonitrile-styrene copolymer, acrylonitrile styrene acrylate, biaxially-oriented polypropylene, bismaleimide triazine, cellulose acetate, cellulose acetate butyrate, cellulose acetate propionate, chlorinated polyethylene, chlorinated vinyl chloride, diallylphthalate, an ethylene-chlorotrifluoroethylene copolymer, ethylene ethyl acrylate, an epoxy resin, an ethylene-propylene-diene ternary copolymer, an ethylene-tetrafluoroethylene copolymer, an ethylene-vinyl acetate copolymer, ethyl vinyl ether, an ethylene-vinylalcohol copolymer, oriented polypropylene, polycarbonate, polyamide, polyacrylic acid, polyaryl ether ketone, polyacrylonitrile, polyarylate, a polyamideimide resin, a polyester alkyd resin, polyparaphenylene benzobisoxazole, polychlorotrifluoroethylene, polydicyclopentadiene, polyethylene, polyether ether ketone, polyetherimide, polyether nitrile, polyethylene naphthalate, polyethylene oxide, polyether sulfone, polythylene telephthalate, phenol-formaldehyde, polyisobutylene, polymethylmethacrylate, polymethylpentene, polyoxymethylene, polypropylene, polyphthalamide, a polypropylene copolymer, polyphenylene ether, polyphenylene oxide, polyphenylene sulfide, polystyrene, polysulfone, poly-ethylene chloride trifluoride, polytetrafluoroethylene, polytrimethylene terephthalate, reactive polyurethane, polyvinyl alcohol, polyvinyl acetate, polyvinyl butyral, polyvinyl chloride, polyvinylidene chloride, polyvinylidene fluoroethylene, polyvinyl fluoride, polyvinyl formal, a styrene block copolymer, a styrene-butadiene-styrene block copolymer, a styrene-ethylene-butylene-styrene block copolymer, a styrene-ethylene-propylene-styrene block copolymer, silicone, a styrene-isoprene-styrene block copolymer, syndiotactic polystyrene, tris(nonylphenyl)phosphate, thermoplastic elastomer, thermopolyolefin, triphenyl phosphate, thermoplastic polyurethane, thermoplastic vulcanized elastomer, vulcanized thermoplastic elastomer, methyl pentene, a urea-formaldehyde resin, ultra high molecular weight polyethylene, an epoxy resin, ethyl cellulose, and the like.

A transparent metal oxide material is used as the inorganic filler. Specifically, the inorganic filler is at least one selected from SiO₂, Al₂O₃, ZrO₂, CeO₂, TiO₂, ITO, ATO, PTO, FTO, IFO, AZO, GZO, IZO, FZO, and ZnO.

From the viewpoint of transmission of visible light, the particle diameter of the filler is preferably in the range of from 1 to 100 nm in terms of an average particle diameter of primary particles.

It is desirable that the shape of the filler be at least one selected from a spherical shape, a cubic shape, a spindle shape, a rod shape, a needle shape, a wire shape, and a tube shape.

### <2. Manufacturing of Transparent Conductive Element>

Manufacturing of the transparent conductive element will be described.

A coating material for the transparent conductive film 2 is manufactured through the following process.

A conductive metal oxide filler is dispersed in a solvent. As a dispersion method, stirring, ultrasonic dispersion, bead dispersion, kneading, homogenizer processing, or the like can be preferably applied.

A mixing amount of the filler is in the range of from 1 to 60 parts by weight when a coating material weight is 100 parts by weight. When the mixing amount is less than 1 part by weight, a sufficient thickness of the dried film may not be obtained when the film is formed by coating. On the other hand, when the mixing amount is greater than 60 parts by weight, the viscosity of the coating material excessively increases, whereby handling during the film formation becomes difficult.

The formation of the transparent conductive film 2 and the protective layer 3 is as follows.

The method of manufacturing the transparent conductive film 2 formed of a conductive metal oxide filler on the base 1 is not particularly limited. However, a wet film manufacturing method is preferably used in consideration of physical properties, convenience, manufacturing cost and the like, and examples of existing wet film manufacturing methods include coating, spraying, printing and the like.

The coating method is not particularly limited, and existing coating methods can be used. Examples of the existing coating methods include a micro gravure coating method, a wire-bar coating method, a direct gravure coating method, a die coating method, a dipping method, a spray coating method, a reverse roll coating method, a curtain coating method, a comma coating method, a knife coating method, a spin coating method, a kiss coating method, and the like.

Examples of the printing method include relief printing, offset printing, gravure printing, intaglio printing, rubber plate printing, screen printing, and the like.

It is desirable that the thickness of the transparent conductive film 2 in FIGS. 1A and 1B be in the range of from 10 nm to 5 μm. When the thickness is less than 10 nm, the sheet resistance value of the transparent conductive film increases and no better conductive property may be obtained. Accordingly, the appropriate thickness is 10 nm or greater. In addition, the greater the film thickness, the less the sheet resistance, but when the film thickness is greater than 5 μm, transparency tends to be reduced. Therefore, the thickness is preferably 5 μm or less.

The base 1 is coated with a transparent conductive material, and then the solvent is dried. Any of natural dying and heating drying may be employed. The heating drying may be combined with the following baking process.

The transparent conductive film 2 is preferably formed as follows. That is, a support (base 1) is coated with a conductive metal oxide filler coating material and the coating material is dried. Then, particles are electronically brought into contact with each other, and baking is performed in order to improve the film strength and adhesion with the substrate.

The baking is preferably performed under the conditions not to replenish the oxygen deficiency in the ITO film. When the oxygen deficiency is replenished, the carrier resulting from the oxygen deficiency is lost, and thus the carrier density is reduced and the sheet resistance of the ITO film increases. As a condition not to replenish the oxygen deficiency, for example, the baking may be performed in a vacuum or in an inert gas such as N₂ or Ar.

The baking temperature range is from 40° C. to 600° C. Particularly, the higher the temperature, the crystallinity of the ITO film is easily improved. However, when the temperature is excessively raised, the base 1 may be thermally damaged. Accordingly, in the case of a plastic base, the temperature is preferably 200° C. or lower.

The baking method is not particularly limited. Examples of the baking method include a hot plate, an electronic furnace, an IH treatment, frame irradiation heating, microwave irradiation heating, lamp irradiation heating, infrared irradiation heating, near-infrared irradiation heating, and the like.

When a plastic base is used as the base 1, heating at a high temperature is possible by irradiation heating. When the base 1 is irradiated with light while being cooled by a cooling plate installed below the base 1, thermal damage of the plastic base is suppressed and the conductive metal oxide filler layer can be treated at a higher temperature.

The baking time is not particularly limited. In general, the baking time is in the range of from about 1 second to about 10 hours.

The base 1 is coated with the conductive metal oxide filler coating material and pressure bonding to the substrate using a heating and pressing press can also be performed. When a plastic base is used, pressure bonding to the substrate using a heating and pressing roll press can also be performed.

The method of manufacturing the protective layer 3 on the transparent conductive film 2 is not particularly limited. However, for example, a resin is dissolved in a solvent, and with the resultant material, the transparent conductive film 2 is coated. Examples of the coating method include the methods described above in the method of manufacturing the transparent conductive film 2.

The protective layer 3 in FIGS. 1A and 1B is formed by penetration into at least some pores in the transparent conductive film 2.

It is desirable that the thickness of the protective layer 3 from the surface of the transparent conductive film 2 be in the range of from 10 nm to 5 μm. However, the thickness is not limited to the range if, by the protective layer 3, the surface of the conductive metal oxide filler does not come into contact with the atmosphere and optical characteristics do not deteriorate.

Furthermore, in order to improve the adhesion, as shown in FIG. 1B, the anchor layer 4 may be separately provided on the base 1 before coating of the conductive metal oxide filler coating material.

In the anchor layer 4, hydrolyzed dehydration condensates of polyacrylic materials, polyamide materials, polyester materials and metal alkoxides can be used.

In addition, it is desirable that the thickness of the anchor layer 4 be a thickness which does not excessively worsen the optical characteristics of the transparent conductive film.

### <3. Processes of Manufacturing Transparent Conductive Film Formed to Have Pattern>

Hereinafter, processes of manufacturing a transparent conductive element (transparent conductive film) according to the embodiment when the element is used as, for example, an electrode element of a capacitive touch panel will be described.

Regarding this, a conductive material is formed so as to form a predetermined electrode pattern as the transparent conductive film 2.

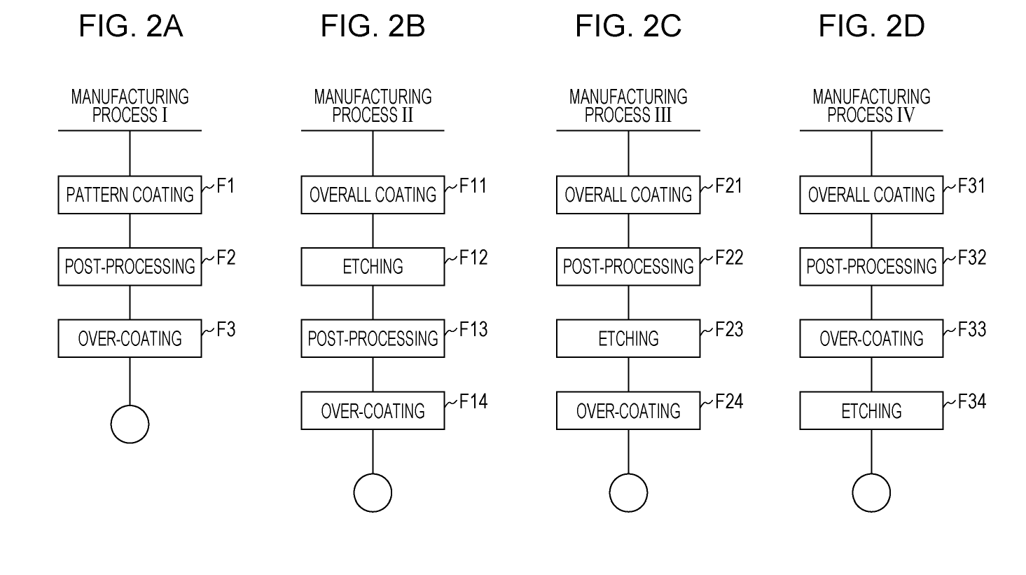

For example, in FIGS. 2A, 2B, 2C, and 2D, manufacturing processes I, II, III, and IV will be exemplified.

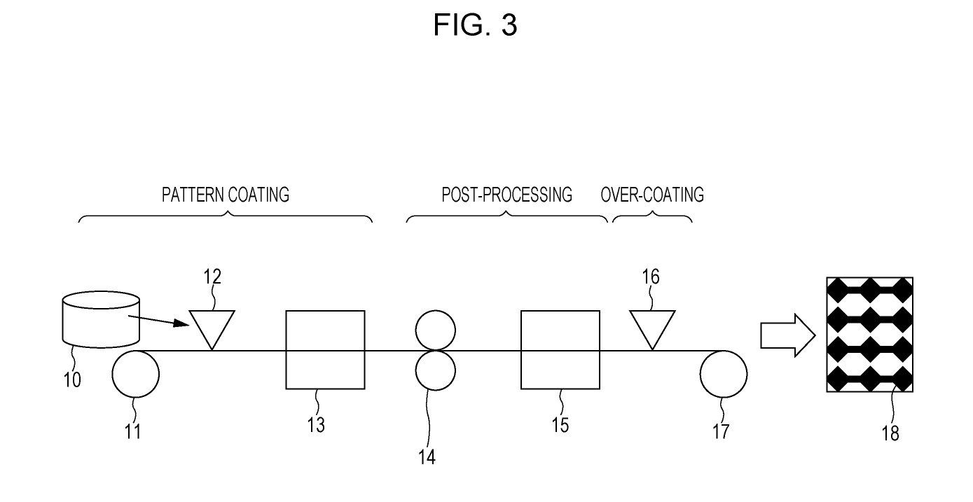

In the manufacturing process I of FIG. 2A, first, pattern coating of a conductive metal oxide filler coating material is performed in Step F1. FIG. 3 schematically shows the manufacturing process I.

A coating material in which a conductive metal oxide filler is dispersed in a solvent is stored in a coating material storing portion 10. The coating material is supplied from the coating material storing portion 10 to a coating device 12.

A sheet-like base (before cutting) is supplied from a supply roll 11 toward a winding roll 17.

In the coating device 12, pattern coating is performed so as to form an electrode pattern of the transparent conductive film 2 on the base sheet.

The coating material applied to have a pattern is dried by a drier 13.

The pattern coating method is not particularly limited, and existing coating methods can be used.

Examples of the existing coating methods include a micro gravure coating method, a direct gravure coating method, a die coating method, a spray coating method, a reverse roll coating method, a curtain coating method, a comma coating method, a knife coating method, a kiss coating method, and the like.

Examples of the printing method include relief printing, offset printing, gravure printing, intaglio printing, rubber plate printing, screen printing, and the like.

Next, post-processing is performed in Step F2.

Examples of the post-processing include pressing (calender process) and baking.

By the pressing, a decrease in the resistance, high transparency, and an improvement in the film quality of the transparent conductive film 2 are achieved.

By the baking, an improvement in crystallinity, a decrease in the resistance, and an improvement in the film quality of the transparent conductive film 2 are achieved.

The example of FIG. 3 shows an example in which pressing is performed by a pressing roll 14.

In addition, baking is performed by a baking device 15. In the baking device 15, annealing is performed in an inert gas. As described above, infrared irradiation heating, lamp irradiation heating (FLA: flash-lamp annealing), or the like may be employed.

Next to the post-processing, the protective layer 3 is formed in an over-coating process of Step F3. As shown in FIG. 3, by an over-coating device 16, the transparent conductive film 2 formed to have a pattern is coated with a resin material or a material in which a filler is mixed with a resin. Due to the protective layer 3, suppression of deterioration with the lapse of time, high transparency, and imparting resistance to the film are promoted.

The base sheet subjected to the above-described processes is cut, and a transparent conductive element is manufactured which has the transparent conductive film 2 having an electrode pattern 18 formed thereon as shown in the drawing.

Here, an example is shown in which as the electrode pattern 18, a conductive portion in which approximately rhombus portions are connected to each other is formed. However, the electrode pattern may have various shapes.

In this manufacturing process I, the electrode pattern is formed by pattern coating. However, the pattern may be formed by etching. The manufacturing processes II, III, and IV show this case.

In the manufacturing process II shown in FIG. 2B, the entire surface of a base sheet is coated with a coating material in Step F11. Etching is performed in Step F12 to form an electrode pattern. Thereafter, pressing, baking and the like are performed as post-processing in Step F13, and coating of the protective layer 3 is performed in Step F14.

In the manufacturing process III shown in FIG. 2C, the entire surface of a base sheet is coated with a coating material in Step F21. In Step F22, pressing, baking and the like are performed as post-processing, and then etching is performed in Step F23 to form an electrode pattern. Thereafter, coating of the protective layer 3 is performed in Step F24.

In the manufacturing process IV shown in FIG. 2D, the entire surface of a base sheet is coated with a coating material in Step F31. In Step F32, pressing, baking and the like are performed as post-processing. Here, coating of the protective layer 3 is performed in advance in Step F33, and finally, etching is performed in Step F34 to form an electrode pattern.

With the above-described processes II to IV, a transparent conductive element can be manufactured which has the transparent conductive film 2 having a predetermined electrode pattern formed thereon.

The R2R process is excellent as a film manufacturing process since the manufacturing cost and facility investment are small.

In addition, in recent years, transparent conductive films have attracted attention since these are used as a major member in electronic industries such as touch panels, FPD, solar cells, EMI, and optical filters.

The transparent conductive film has been considered in a wet process as well as a dry process. However, there is a problem in that the sheet resistance deteriorates with the lapse of time after film formation. Accordingly, the inventors of the present disclosure have developed a transparent conductive element in which the protective layer 3 is provided to suppress deterioration with the lapse of time. Therefore, it is possible to manufacture transparent conductive elements having no deterioration with the lapse of time by a R2R process at a low cost in large numbers.

### <4. Input Device Using Transparent Conductive Element>

For example, a transparent conductive element according to the embodiment which is manufactured as described above is appropriately used as an input device of a touch panel and the like, particularly, an electrode element of a capacitive touch panel and the like.

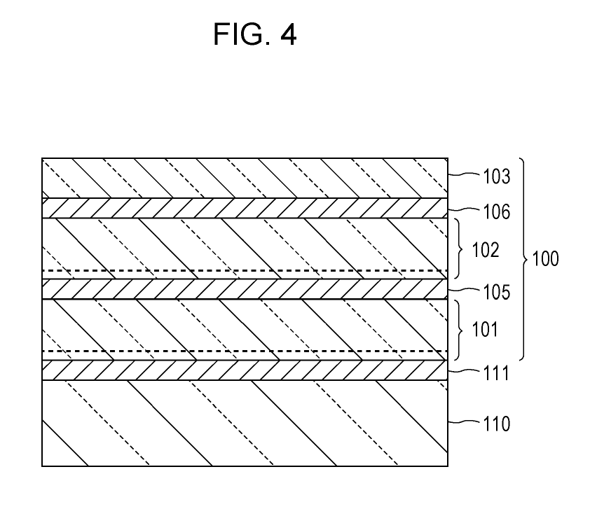

FIG. 4 shows the structure of an input device using the transparent conductive element according to the embodiment.

As shown in the drawing, an input device 100 is provided on a display surface of a display device 110. The input device 100 is stuck to the display surface of the display device 110 by, for example, a sticking layer 111.

The input device 100 is a so-called projection type capacitive touch panel and is provided with a first transparent conductive element 101 and a second transparent conductive element 102 provided on a surface of the transparent conductive element 101. For example, the transparent conductive element 101 forms an X electrode, and the transparent conductive element 102 forms a Y electrode.

The transparent conductive elements 101 and 102 are stuck to each other via a sticking layer 105.

In addition, if necessary, an optical layer 103 such as an AR film may be further provided on a surface of the transparent conductive element 102. The optical layer 103 can also be formed by ceramic coating (over-coating) of SiO₂ or the like.

Here, the transparent conductive element according to this embodiment can be employed as the first and second transparent conductive elements 101 and 102. That is, as shown in FIGS. 1A and 1B, the transparent conductive elements 101 and 102 have a configuration in which the transparent conductive layer 2 is formed on the surface of the base 1 and the protective layer 3 is further provided.

The display device 110 to which the input device 100 is applied is not particularly limited, but examples thereof include various display devices such as a liquid crystal display, a Cathode Ray Tube (CRT) display, a Plasma Display Panel (PDP), an Electro Luminescence (EL) display, and a Surface-conduction Electron-emitter Display (SED).

### EXAMPLES

Hereinafter, examples of the transparent conductive element according to the present disclosure will be shown with comparative examples.

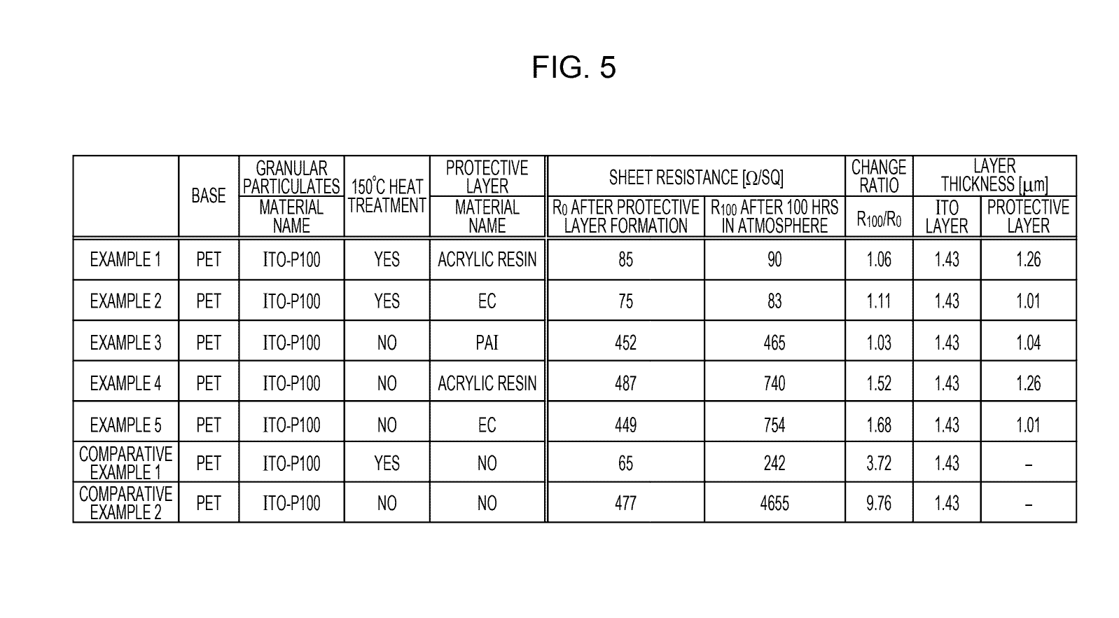

FIG. 5 shows a list of materials, processes and evaluation results of Examples #1 to #5 and Comparative Examples #1 and #2.

In all of the examples and the comparative examples, PET was used as the base 1 and ITO was used as granular particulates of the transparent conductive film 2. All of the film thicknesses are 1.43 μm.

The difference between Examples #1 to #5 and Comparative Examples #1 and #2 is the presence of the protective layer 3.

The difference between the respective Examples #1 to #5 is a combination of the presence of a heat treatment and a material (acrylic resin, ethyl cellulose (EC), and polyamide-imide (PAI)) of the protective layer 3.

In Examples #1 and #4 using an acrylic resin, the film thickness of the protective layer 3 is 1.26 μm, in Examples #2 and #5 using EC, the film thickness of the protective layer 3 is 1.01 μm, and in Example #3 using PAI, the film thickness of the protective layer 3 is 1.04 μm.

The difference between Comparative Examples #1 and #2 is the presence of a heat treatment.

The sheet resistance of each sample was measured after manufacturing (after formation of the protective layer) and after lapse of 100 hours in the atmosphere.

### <Evaluation Method>

The sheet resistance was evaluated by Loresta EP and MCP-T360 manufactured by Mitsubishi Chemical Analytech Co., Ltd., and EC-80P manufactured by Napson Corporation.
HAZE (JIS K7136) and a total light transmission (JIS K7361) were evaluated by HM-150 manufactured by Murakami Color Research Laboratory Co., Ltd.
The film thickness of the ITO layer (transparent conductive film 2) was obtained as follows. After formation of the ITO layer, a part of the film was scraped from the base, and a step from the surface of the film to the surface of the base was evaluated by a contact needle type surface roughness measuring machine (manufactured by Kosaka Laboratory Ltd., product name: SURF-CORDER ET-4000).
The film thickness of the protective layer 3 (defined as a thickness from the surface of the ITO layer to the surface of the protective layer) was obtained as follows. After formation of the protective layer, a part of the ITO layer and a part of the protective layer were scraped from the base, and a step from the surface of the protective layer 3 to the surface of the base 1 was evaluated by a contact needle type surface roughness measuring machine (manufactured by Kosaka Laboratory Ltd., product name: SURF-CORDER ET-4000). The film thickness of the ITO layer was subtracted from the evaluated value.

The respective film thicknesses can be obtained by observing a cross-section of a sample, cut out by a microtome or the like, with an SEM or the like.
Regarding deterioration with the lapse of time, the sheet resistance was measured immediately after manufacturing of a sample, and then the sample was stored for 100 hours in the atmosphere at room temperature and the sheet resistance was measured again. Since the protective layer 3 used at this time is an insulating body, the sheet resistance after formation of the protective layer was evaluated by a noncontact resistance measuring machine EC-80P manufactured by Napson Corporation.

### <Adjustment of Conductive Metal Oxide Filler Coating Material>

An ITO filler (ITO-P100 manufactured by Shanghai Huzheng Nanotechnology Co., Ltd., particle diameter: 20 to 30 nm) was used as a conductive metal oxide filler.

A powder and ethanol were mixed so that an ITO weight content was in the range of 20 to 30 wt %. Using φ0.65 mm-zirconia beads, a bead dispersion process was performed for 0.5 to 24 hours using a paint shaker to prepare an ITO sol.

### <Transparent Conductive Film Manufacturing Method>

A transparent conductive film was manufactured in the following order.
[1] A PET film substrate (manufactured by Mitsubishi Plastics, Inc., O300E-125) was over-coated with the ITO paint, and then the ITO paint was dried for 2 minutes by an oven at 80° C.
[2] The film was cut out into a width of 5 cm and the cut film was pressurized using a calender having a press roll and a back roll at a surface temperature of 80° C. at a line speed of 21 cm/min and a line pressure of 7000 N/5 cm. Thereafter, baking was performed for 1 hour in an oven at 150° C. in a nitrogen atmosphere.
[3] Next, as a protective layer, an ethanol solution of ethyl cellulose (ethyl cellulose (about 49% ethoxy) manufactured by Wako Pure Chemical Industries, Ltd. was dissolved in ethanol at a solid content of 0 wt %) or an NMP solution of polyamide-imide (manufactured by Toyobo Co., Ltd., Vylomax HR-11NN; solid content 15 wt %, NMP solution) was over-coated on the film of [2], and then dried for 2 minutes in an oven at 80° C. or an oven at 120° C. to obtain a transparent conductive film. Otherwise, an UV acrylic coating material having the following composition was over-coated on the film of [2], and then dried for 2 minutes in an oven at 80° C. and irradiated with UV light at an integrated light quantity of 300 mJ/cm² to form an UV acrylic layer.

The composition of an UV acrylic coating material is as follows.
Hexafunctional urethane acrylate (manufactured by Sartomer Company, trade name: CN9006) 38 parts by mass
Polymerization initiator (manufactured by Ciba Specialty Chemicals Inc., product name: Irgacure 184) 2 parts by mass
Solvent: methyl isobutyl ketone (MIBK) 60 parts by mass

The measurement results of the examples and the comparative examples manufactured as described above are shown in FIG. 5.

The results are as follows.

The sheet resistance change ratio is preferably 2 or lower, more preferably 1.5 or lower, and even more preferably 1.2 or lower.

All the sheet resistance change ratios of the transparent conductive films (Examples #1 to #5) which are protective layers 3 during the storage in the atmosphere are low, that is, lower than 1.7, but the change ratios of the transparent conductive films (Comparative Examples #1 and #2) having no protective layer 3 are high, that is, 3.7 or higher.

The sheet resistance change ratios of the transparent conductive films (Examples #1and #2), on which the protective layer 3 is formed by baking at 150° C., during the storage in the atmosphere are low, that is 1.2 or lower, but the sheet resistance change ratios of the transparent conductive films (Examples #4 and #5), on which the protective layer is formed without baking at 150° C., are 1.5 to 2.

In Example #3, the change ratio is low regardless of the fact that baking at 150° C. has not been performed. The reason for this is thought that the polyamide-imide resin has an excellent function to bring the ITO film into non-contact with the atmosphere.

All the change ratios of the transparent conductive films (Comparative Examples #1 and #2) having no protective layer are higher than 2. However, the change ratio of the transparent conductive film (Comparative Example #1) subjected to baking at 150° C. is suppressed to be lower.

From the results, the following is postulated.

It is thought that due to baking at 150° C., the crystallinity of the ITO film is improved (scattering occurring by lattice defect is suppressed), and thus the sheet resistance is improved and it is difficult for the oxygen which is a cause of deterioration in the sheet resistance to adhere to the surface of the ITO film, whereby little deterioration with the lapse of time is caused (electron traps due to the adsorbed oxygen are reduced).

It is thought that due to formation of the protective layer 3, the surface of the ITO film (transparent conductive film 2) does not come into contact with the atmosphere and the oxygen adsorption is thus suppressed, whereby little deterioration with the lapse of time is caused.

As described above, the embodiments and examples of the present disclosure have been described in detail. However, the technique of the present disclosure is not limited to the above-described embodiments and examples, and various modifications can be made.

For example, the configurations, methods, processes, shapes, materials, numerical values and the like shown in the above-described embodiments and examples are just an example, and if necessary, different configurations, methods, processes, shapes, materials, numerical values and the like may be used.

In addition, the configurations, methods, processes, shapes, materials, numerical values and the like of the above-described embodiments can be combined with each other without departing from the gist of the present disclosure.

The present disclosure can employ the following configurations.
(1) A transparent conductive element including: a base; a transparent conductive film which is formed of a transparent conductive material on the base; and a protective layer which coats the transparent conductive film.
(2) The transparent conductive element according to (1), in which the protective layer is formed of a resin.
(3) The transparent conductive element according to (1), in which the protective layer is formed of a material in which an inorganic filler is added to a resin.
(4) The transparent conductive element according to any one of (1) to (3), in which the transparent conductive film is formed using a conductive metal oxide filler.
(5) The transparent conductive element according to any one of (1) to (4), in which the transparent conductive film is formed via an anchor layer on the base.

In addition, the present disclosure can also employ the following configurations.
(6) A transparent conductive element manufacturing method including: forming a transparent conductive film by coating a base with a transparent conductive material; subjecting the transparent conductive film to post-processing; and coating the transparent conductive film with a protective layer.
(7) The transparent conductive element manufacturing method according to
(6), in which baking is performed as the post-processing.
(8) The transparent conductive element manufacturing method according to (6) or (7), in which pressing is performed as the post-processing.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A transparent conductive element comprising:
a base;
a transparent conductive film which is formed of a transparent conductive material on the base; and
a protective layer which coats the transparent conductive film.

2. The transparent conductive element according to claim 1,
wherein the protective layer is formed of a resin.

3. The transparent conductive element according to claim 1,
wherein the protective layer is formed of a material in which an inorganic filler is added to a resin.

4. The transparent conductive element according to claim 1,
wherein the transparent conductive film is formed using a conductive metal oxide filler.

5. The transparent conductive element according to claim 1,
wherein the transparent conductive film is formed via an anchor layer on the base.

6. A transparent conductive element manufacturing method comprising:
forming a transparent conductive film by coating a base with a transparent conductive material;
subjecting the transparent conductive film to post-processing; and
coating the transparent conductive film with a protective layer.

7. The transparent conductive element manufacturing method according to claim 6,
wherein baking is performed as the post-processing.

8. The transparent conductive element manufacturing method according to claim 6,
wherein pressing is performed as the post-processing.
